(19) United States
(12) Patent Application Publication
(10) Pub. No.: US 2004/0043266 A1
(43) Pub. Date: Mar. 4, 2004

(54) Solid polymer type fuel cell system

(76) Inventors: Atsushi Oma, Kanagawa (JP); Yasuji Ogami, Kanagawa (JP); Yasuhiro Arai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/363,859

(22) PCT Filed: Sep. 14, 2001
(86) PCT No.: PCT/JP01/08013

(30) Foreign Application Priority Data
Sep. 14, 2000 (JP) 2000-280682

(51) Int. Cl. H01M 8/04; H01M 8/10; H01M 8/06

(52) U.S. Cl. 429/26; 429/20; 429/30

(57) ABSTRACT

A solid polymer type fuel cell system according to the present invention has a heat source of exhaust fluid from an electricity generation unit 23 in condensed heat exchangers 38, 40 in a heat recovery unit 19 and supply water from a water supply unit 66 as a heat source to be heated to a hot water through heat-exchanging process. The fuel cell system comprises a hot water supply unit 41 for supplying the hot water to a heat utilization section, gas-liquid separator 30 for preliminarily mixing the drain water generated during the heat-exchanging process to the fuel to be supplied to a fuel reforming unit 22, and a circulation path 45 for circulating the water to a cell body 32 of the electricity generation unit to carry out the heat-exchanging and supplying the hot water to the heat utilization section. According to this structure, there can be provided the solid polymer type fuel cell system in which the drain water contained in the combustion exhaust gas can be effectively and fully recovered and the recovered drain water can be also effectively utilized.

### TECHNICAL FIELD

The present invention relates to a solid polymer type fuel cell system, which efficiently recovers condensed water from an exhaust gas and provides an efficient use of thermal energy as used when recovering the condensed water from the exhaust gas.

### BACKGROUND OF THE INVENTION

With respect to an energy conversion apparatus having high efficiency, a fuel cell system has recently been notice widely. Some types of the fuel cell system have been operated or research and development thereof have been carried out. Of these systems, a solid polymer type fuel cell system, which utilizes a polymer membrane having a proton conductivity as electrolyte so as to provide a high power density with a compact structure and enable an operation with a simple system, has become a focus of attention in the field of stationary distributed power sources as well as the other power source used in space or vehicles. Such a power source has a structure as shown in FIGS. 9 and 10.

The solid polymer type fuel cell system includes three components into which the system is broadly divided, i.e., an electricity-generating system of a cell body, a fuel reforming system and a heat recovery system. The cell body of the electricity-generating system has a structure as described below.

The solid polymer type cell body is composed of a membrane electrode composite 4, which is provided with a polymer membrane 1, a sheet-shaped fuel electrode 2 serving as a gas diffusion electrode and an oxidant electrode 3.

In the membrane electrode composite 4, the polymer membrane 1 is held between the fuel electrode 2 serving as the diffusion electrode including catalyst of platinum and the oxidant electrode 3.

The membrane electrode composite 4, which includes the polymer membrane 1, the fuel electrode 2 and the oxidant electrode 3, is usually formed into a sheet having a square or rectangular shape.

The polymer membrane 1 is provided with a gasket 5 as shown in FIG. 11, which increases an area of the polymer membrane 1 larger than the fuel electrode 2 and the oxidant electrode 3 and enables it to come sufficiently into contact with reaction gases, which are to be supplied to the respective electrodes 2, 3, thus preventing occurrence of mixture or disturbance of the reaction gases In addition, the polymer membrane 1 has a through-hole 6 serving as a manifold so as to cross the reaction gas at right angles.

There is a need to supply a fuel gas and an oxidant gas serving as the reaction gases to the respective electrodes 2, 3 in order to draw electricity out of the membrane electrode composite 4. In this case, are forming gas having a principal component of hydrogen (i.e., fuel generated from hydrocarbon) is used as the fuel gas, and oxygen contained in air is used as the oxidant gas.

The following chemical reaction occurs so that hydrogen included in the fuel gas, which is supplied to the fuel electrode 2, becomes proton and an electron:

H₂→2H⁺+2e⁻ (1)

In the reaction expressed by the equation (1), the proton is transferred from the fuel electrode 2 to the oxidant electrode 3 in the polymer membrane 1 having a function of electrolyte. The electron is not capable of transferring in the polymer membrane 1, but is transferred to the oxidant electrode 3 through an external electric circuit.

In the oxidant electrode 3, the following chemical reaction occurs between the proton and the electron as transferred from the fuel electrode 2 and the oxygen serving as the oxidant to generate water:

2H⁺+1/2O₂+2e⁻→2H²O (2)

The thus generated water is generally called “generated water”. The generated water evaporates in the oxidant gas to become water vapor and to be discharged outside of the cell.

At this stage, electromotive forces (EMF difference) are generated in both the electrodes 2, 3. A separator 7 is provided as shown in FIG. 11 so as to utilize the electromotive forces and prevent occurrence of mixture or disturbance of the reaction gases supplied to the respective electrodes 2, 3. The separator 7 is integrally formed with the sides of the fuel electrode 2 and the oxidant electrode 3 to form a unit cell 8.

FIG. 11 is a schematic drawing illustrating the unit cell 8. The unit cell 8 is composed of the membrane electrode composite 4, the fuel electrode 2, the oxidant electrode 3, the separator 7 and the gasket 5. The separator 7 has reaction gas supplying holes (supplying manifolds) 9 for supplying the reaction gases to the respective unit sell 8, reaction gas discharging holes (discharging manifolds) 10 for discharging the reaction gases from the respective unit sell 8, and fuel gas passages 11 and oxidant gas passages 12 for connecting the reaction gas supplying holes 9 and the reaction gas discharging holes 10 to each other.

The electromotive force generated in the unit cell 8, which includes the single membrane electrode composite 4, is small of up to 1V. Accordingly, the unit cells 8 are placed one upon another in the form of laminate structure and subjected to an electric connection in series to provide a stack 13, thus increasing the electromotive force. The stack 13 is fastened by means of a fastening mechanism such as a spring and a rod, after completion of the staking step of the unit sells 8. In addition, the stack 13 is provided with a cooling plate (not shown) for cooling each of the unit cells 8. Japanese Laid-Open Patent Application No. H01-140562 discloses measures to cool the stack 13 without using any cooling plate.

Now, the fuel reforming system will be described below.

The fuel gas supplied to the fuel electrode 2 mainly contains hydrogen. It is however difficult to supply the hydrogen with high purity. In view of these circumstances, the reforming gas is formed with the use of hydrocarbon fuel such as methane CH₄, propane C₃H₈, methanol CH₃OH and catalyst and the thus formed reforming gas is supplied to the cell body 15. The system for forming the reforming gas is hereinafter referred to as the “fuel reforming system” 14.

The fuel reforming system 14 adds water vapor to, for example, the methane CH₄ of the hydrocarbon fuel so as to reform the hydrogen in accordance with the following equation:

CH₄+2H₂O→4H₂+CO₂

The above-mentioned equation is based on an endothermic reaction, thus loosing its balance with no application of heat. Accordingly, the fuel reforming system 14 returns the residual hydrogen H₂, which has remained after supplying the hydrogen H₂ as reformed for example from the methane CH₄ to the cell body 15, and then, adds air to the residual hydrogen to burn it.

With respect to the fuel reforming system 14, there exists, as an oxygen adding system, a system of adding oxygen O₂ to, for example, the methane CH₄ of the hydrocarbon fuel to generate hydrogen H₂ and carbon monoxide CO in accordance with the following equation (3) and then supplying the hydrogen to the cell body 15:

CH₄+1/2O₂→2H₂+CO (1)

Such a system however generates the carbon monoxide CO, thus causing unfavorable matters in operation. In vie of these aspects, there exists an improved fuel reforming system 14 in which a reforming reactor 16 is combined with a CO transformer 17 and a selective oxidizer 18, water vapor H₂O is added to, for example, the methane CH₄ Of the hydrocarbon fuel, the water vapor H₂O is added to the generated carbon monoxide CO in the CO transformer 17 to generate hydrogen H2 and carbon dioxide CO₂ in accordance with the following equation (4) and oxygen O₂ contained in air is added to generate carbon dioxide CO₂ in accordance with the following equation (5):

CO transformer:CO+H₂O→H₂+CO₂ (4)

CO selective oxidizer:CO+1/2O₂→CO₂ (5)

Now, the heat recovery system will be described below.

The heat recovery system includes a type of utilizing heat from refrigerant, which is supplied, for the purpose of cooling, to the cell body 15 and a type of recovering exhaust heat generated from the fuel reforming system 14. The former heat recovery system 19 in which the refrigerant supplied for the purpose of cooling to the cell body 15 recovers heat and then is supplied as heat medium to the heat exchanger 20 as shown in FIG. 16, and then, makes a heat exchange with the other refrigerant to provide heat utilization for hot-water supply or heating, is disclosed for example in Japanese Laid-Open Patent Application No. H10-311564.

The latter heat recovery system 19 in which combustion exhaust gas is supplied from the fuel reforming system 14 to the heat exchanger 20 through the cell body 15, the CO transformer 17 and the CO selective oxidizer 18 as shown in FIG. 17, and then heat-exchange with the refrigerant is made so as to provide heat utilization for hot-water supply or heating, or in which the refrigerant supplied to the heat exchanger 20 is converted into heat medium so as to provide heat utilization for hot-water supply, when supplying the combustion exhaust gas from the fuel reforming system 14 to the cell body 15 through the heat exchanger 20, is disclosed for example in Japanese Laid-Open Patent Application No. H08-287932.

In addition, the heat recovering system 19 also includes recovery of water from the cell body 15 and the fuel reforming system 14. Especially, the cell body 15 utilizes a large amount of pure water, with the result that there is need to make water in the cell body independent.

The concrete measures of making water independent include a type of making heat exchange between the combustion exhaust gas and the refrigerant in the heat recovering system 19 as shown for example in FIG. 19 so as to recover water contained in the combustion exhaust gas in the form of drain (i.e., condensed water), a type of making heat exchange between the combustion exhaust gas and ambient air in the heat recovering system 19 as shown for example in FIG. 20 so as to release heat into the ambient air by means of a fan 21 and recover water from the combustion exhaust gas in the form of drain (i.e., condensed water) and a type of making heat exchange between the combustion exhaust gas and refrigerant as circulated as shown for example in FIG. 21 so as to recover water from the combustion exhaust gas in the form of drain (i.e., condensed water).

The conventional solid polymer type fuel cell system utilizes the cell body, the fuel reforming system and the heat recovering system in a skillful combination to provide an energy conversion with high efficiency.

The conventional solid polymer type fuel cell system as shown in FIGS. 9 to 21 has some problems, especially, the problems of recovery of drain (i.e., condensed water) when making water independent.

The conventional solid polymer type fuel cell system makes heat exchange between the refrigerant or air and the combustion exhaust gas as described above, when recovering the water contained in the combustion exhaust gas in the form of drain, thus causing many problems on defects and inconvenience of fluctuations in amount of drain due to temperature of ambient air, failure in making the water independent at a high atmospheric temperature in the summer season, an excessively increased heat transfer face in case of a gas/gas heat exchange and a limited dew point of the combustion exhaust gas due to limitation in temperature effectiveness with the use of a fan.

An object of the present invention, which was made in view of the above-described circumstances, is to provide a solid polymer type fuel cell system, which provides effective and sufficient recovery of drain contained in a combustion exhaust gas and an effective utilization of the drain as recovered.

### DISCLOSURE OF THE INVENTION

In order to achieve the aforementioned object, the solid polymer type fuel cell system, in which a fuel reforming system and a heat recovery system are combined with an electricity-generating system for chemically generating electricity, is characterized in that the heat recovery system comprises a water supply unit; a condensation heat exchange unit for converting water supplied from the water supply unit into hot water; and a hot water storage unit for temporarily storing the hot water from the condensation heat exchange unit and supplying same to a heat application unit.

In a preferred embodiment of the above-described aspect of the solid polymer type fuel cell system, the condensation heat exchange unit is divided into a first condensation heat exchange section and a second condensation heat exchange section, the first condensation heat exchange section being connected with a side of a fuel electrode of a cell body and the second condensation heat exchange section being connected with a side of at least an oxidant electrode of the cell body, in order to achieve the aforementioned object.

The condensation heat exchange unit may be divided into a gas-liquid separation section and a second condensation heat exchange section, the gas-liquid separation section being connected with a side of a fuel electrode of a cell body and the second condensation heat exchange section being connected with a side of at least an oxidant electrode of the cell body.

The first condensation heat exchange section and the second condensation heat exchange section may be provided at respective bottoms thereof with a common drain pool.

The gas-liquid separation section and the second condensation heat exchange section may be provided at respective bottoms thereof with a common drain pool.

The drain pool may be provided with an air supply unit.

The hot water storage unit may be a hot water tank.

The hot water storage unit may be provided with a sub-burning unit for heating the hot water, which is supplied from the condensation heat exchange unit, utilizing at least one of a part of fuel supplied to the fuel reforming system and unreacted fuel discharged from the electricity-generating system.

The hot water storage unit may be provided with a control valve for controlling a flow rate of the hot water supplied from the condensation heat exchange unit and with a valve-opening computing unit for processing a valve opening signal based on a temperature signal for the hot water and supplying same to the control valve.

The hot water storage unit may be a bathtub.

The bathtub may be provided with a heat exchange section received in a wall portion thereof, the heat exchange section being provided with a device for supplying the hot water from the condensation heat exchange unit and with a device for returning the hot water from the heat exchange section to an inlet of the condensation heat exchange unit.

Further, In order to achieve the aforementioned object, the solid polymer type fuel cell system, in which a fuel reforming system and a heat recovery system are combined with an electricity-generating system for chemically generating electricity, is characterized in that the heat recovery system comprises a water supply unit; a condensation heat exchange unit for converting water supplied from the water supply unit into hot water; a bathtub for utilizing the hot water from the condensation heat exchange unit as a hot bath; a heat exchange section for converting air into a hot-air with a use of the hot water from the condensation heat exchange unit as a heating source and supplying the hot-air to a heat application unit; and a device for returning the hot-water discharged from the heat exchange section to a water supply side of the condensation heat exchange unit.

Further, In order to achieve the aforementioned object, the solid polymer type fuel cell system, in which a fuel reforming system and a heat recovery system are combined with an electricity-generating system for chemically generating electricity, is characterized in that the heat recovery system comprises a water supply unit; a condensation heat exchange unit for converting water supplied from the water supply unit into hot water; and a hot water storage unit for temporarily storing the hot water from the condensation heat exchange unit and supplying same to a heat application unit, and the electricity-generating system is provided with a line for supplying part of condensed water, which is generated in the condensation heat exchange unit, to at least one of sides of a fuel electrode of a cell body and an oxidant electrode.

Further, in order to achieve the aforementioned object, the solid polymer type fuel cell system, in which a fuel reforming system and a heat recovery system are combined with an electricity-generating system for chemically generating electricity, is characterized in that the heat recovery system comprises a water supply unit; a condensation heat exchange unit for converting water supplied from the water supply unit into hot water; a device for supplying the hot water from the condensation heat exchange unit to a first heat application unit; a device for supplying the hot water to a second heat application unit, which is provided in parallel with the first heat application unit; a device for returning water, which has passed through the second heat application unit, to a water supply side of the condensation heat exchange unit; and an adjusting device for controlling an amount of heat supplied to the first or second heat application unit.

There may be comprised a hot water storage unit provided on an upstream hot-water side of the first heat application unit and a device for connecting a hot-water discharging side of the hot water storage unit with a hot-water supply side of the second heat application unit.

According to the present invention as described above, the solid polymer type fuel cell system comprises the fuel reforming system, the electricity-generating system and the heat recovery system so that electricity is generated in accordance with the chemical reaction, which is caused in the electricity-generating system, of reformed fuel generated in the fuel reforming system with air, there is made effective and sufficient recovery of drain that is included in the combustion exhaust gas as generated at this stage, to provide effective utilization of the drain as recovered, the exhaust gas is supplied to the heat recovery system to heat water from the water supply unit to provide hot water, utilizing the exhaust gas as a heating source, and supply the hot water to the heat application unit, on the one hand, and the drain as isolated from the exhaust gas is utilized in at least one of generation of the reformed fuel in the fuel reforming system and hot-water supply, on the other hand, thus making the water independent and providing effective utilization of heat.

### BRIEF DESCRIPTION OF THE DRAWINGS

FIG. 1 is a schematic descriptive view illustrating a first embodiment of a solid polymer type fuel cell system according to the present invention;

FIG. 2 is a schematic descriptive view illustrating a second embodiment of the solid polymer type fuel cell system according to the present invention;

FIG. 3 is a schematic descriptive view illustrating a third embodiment of the solid polymer type fuel cell system according to the present invention;

FIG. 4 is a schematic descriptive view illustrating a fourth embodiment of the solid polymer type fuel cell system according to the present invention;

FIG. 5 is a schematic descriptive view illustrating a fifth embodiment of the solid polymer type fuel cell system according to the present invention;

FIG. 6 is a schematic descriptive view illustrating a sixth embodiment of the solid polymer type fuel cell system according to the present invention;

FIG. 7 is a schematic descriptive view illustrating a seventh embodiment of the solid polymer type fuel cell system according to the present invention;

FIG. 8 is a schematic descriptive view illustrating an eighth embodiment of the solid polymer type fuel cell system according to the present invention;

FIG. 9 is a schematic descriptive view illustrating a membrane electrode composite of a conventional solid polymer type fuel cell;

FIG. 10 is a plan view as viewed in a direction of an arrow “A” as shown in FIG. 8;

FIG. 11 is a schematic descriptive view illustrating a unit cell of the conventional solid polymer type fuel cell;

FIG. 12 is a schematic descriptive view illustrating a stack of the conventional solid polymer type fuel cell;

FIG. 13 is a schematic descriptive view illustrating a water vapor adding type fuel reforming system in the conventional solid polymer type fuel cell;

FIG. 14 is a schematic descriptive view illustrating an oxygen adding type fuel reforming system in the conventional solid polymer type fuel cell;

FIG. 15 is a schematic descriptive view illustrating the other fuel reforming system in the conventional solid polymer type fuel cell;

FIG. 16 is a schematic descriptive view illustrating the heat recovery system in the conventional solid polymer type fuel cell;

FIG. 17 is a schematic descriptive view illustrating the heat recovery system in the conventional water vapor adding type fuel reforming system;

FIG. 18 is a schematic descriptive view illustrating the heat recovery system in the conventional water vapor adding type fuel reforming system;

FIG. 19 is a schematic descriptive view illustrating the other heat recovery system in the conventional water vapor adding type fuel reforming system;

FIG. 20 is a schematic descriptive view illustrating the other heat recovery system in the conventional water vapor adding type fuel reforming system; and

FIG. 21 is a schematic descriptive view illustrating the other heat recovery system in the conventional water vapor adding type fuel reforming system.

### BEST MODE FOR CARRYING OUT THE INVENTION

Now, embodiments of a solid polymer type fuel cell system according to the present invention will be described hereunder in detail with reference to the accompanying drawings and reference numerals given thereon.

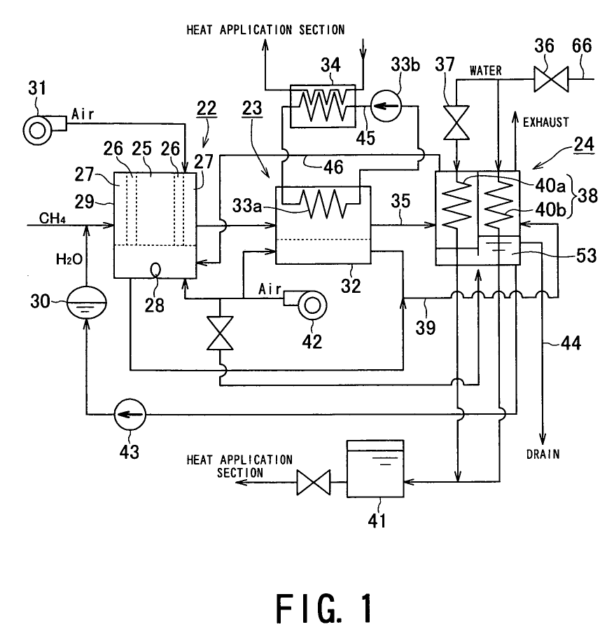

FIG. 1 is a schematic descriptive view illustrating the first embodiment of the solid polymer type fuel cell system according to the present invention.

The solid polymer type fuel cell system according to this embodiment has a structure in which an electricity-generating system 23 and a heat recovery system 24 are combined with a fuel reforming system 22.

The fuel reforming system 22 comprises a reforming unit 29, which includes a fuel reforming section 25, a CO transformer 26, a CO selective oxidizer 27 and a burning section 28; a gas-liquid separation unit 30 of pre-mixing, when supplying fuel, for example methane CH₄ from a fuel supply unit (not shown) to the reforming unit 29, the fuel with water vapor H₂O; and a blower 31 of supplying air to the CO selective oxidizer 27.

The electricity-generating system 23 comprises a cell body 32, which includes a stack (not shown) in which unit cells (not shown), each of which is composed of a fuel electrode, a polymer membrane and an oxidant electrode (all of them are not shown), are placed one upon another in the form of laminate structure; and a hot water heater 34, which is provided on the side of the fuel electrode of the cell body 32 so as to circulate water in a circulation passage 45 provided with a heating section 33a and a pump 33b, heat the water in the heating section 33a, utilizing heat generated when generating electricity on the side of the fuel electrode and supply the hot water to a heat application unit such as a toilet seat.

The heat recovery system 24 comprises a water supply unit 66, a condensation heat exchange unit 38 and a hot water storage unit 41.

The water supply unit 66 is provided with a faucet 36 and a valve 37 so that water supplied from the outside, for example, service water is supplied to the condensation heat exchange unit 38.

The condensation heat exchange unit 38 is divided into the first condensation heat exchange section 40a and the second condensation heat exchange section 40b so that the first condensation heat exchange section 40a is connected with the side of the fuel electrode of the cell body 32 through a fuel-exhaust gas pipe 35 and the second condensation heat exchange section 40b is connected with the side of the oxidant electrode of the cell body 32 through an oxidant-exhaust gas pipe 39.

The first condensation heat exchange section 40a and the second condensation heat exchange section 40b are provided at the respective bottoms thereof with a common drain pool 53 and a blower 42 for supplying air to the drain pool 53.

The hot water storage unit 41 temporarily stores the hot water, which is generated in the first condensation heat exchange section 40a and the second condensation heat exchange section 40b and supplies it to a heat application unit for the purpose of, for example, anus washing.

In the solid polymer type fuel cell system having such a structure, fuel, for example methane CH₄ supplied from the fuel supply unit is subjected to addition of water vapor H₂O from the gas-liquid separation unit 30 and then supplied to the reforming unit 29 of the fuel reforming system 22.

The water vapor reforming system is applied to the reforming-unit 29 so that air is supplied to the CO selective oxidizer 27 by means of the blower 31 when passing the mixture medium of methane CH₄ and water vapor H₂O through the fuel reforming section 25, the CO transformer 26 and the CO selective oxidizer 27 in this order, and a reforming gas mainly containing hydrogen H2 generates. The reforming gas generated in the reforming unit 29 has a CO concentration of about 50 ppm.

The reforming gas generated in the reforming unit 29 is supplied to the side of the fuel electrode of the cell body 32, while air is supplied to the side of the oxidant electrode of the cell body 32 by means of the blower 42. The blower 42 also supplies air to the burning section 28 of the reforming unit 29 as well as the drain pool 53 of the first condensation heat exchange section 40a and the second condensation heat exchange section 40b in the heat recovery system 24. The air, which is to be supplied to the drain pool 53 of the first condensation heat exchange section 40a and the second condensation heat exchange section 40b, causes bubbling in the drain to remove CO₂ therein.

The cell body 23 causes the fuel electrode and the oxidant electrode to react with each other to generate water H₂O and then the exhaust gas on the side of the fuel electrode is supplied to the first condensation heat exchange section 40a through the fuel-exhaust gas pipe 35. At this stage, water, for example, service water supplied from the water supply unit 66 is heated to be hot water. The hot water is temporarily stored in the hot water storage unit 41 and then supplied to the heat application unit for the purpose of, for example, anus washing. The exhaust gas, which is supplied to the first condensation heat exchange section 40a heats water from the water supply unit and is then supplied as a fuel source to the burning section 28 of the reforming unit 29 through an exhaust gas pipe 46.

The cell body 32 supplies the exhaust gas on the side of the oxidant electrode to the second condensation heat exchange section 40b through the oxidant-exhaust gas pipe 39, together with the exhaust gas from the burning section 28. At this stage, the water from the water supply unit 66 is also heated to be hot water. The hot water is temporarily stored in the hot water storage unit 41, while part of the drain is returned to the gas-liquid separation unit 30 and the remaining part is discharged out of the system through a blowpipe 44. The exhaust gas supplied to the second condensation heat exchange section 40b heats the water from the water supply unit 66 and is then released in the atmosphere as exhaust.

In addition, the cell body 32 heats water (i.e., cooling water) passing through the circulation passage 45, in the heating section 33a, utilizing heat, which is generated during reaction between the fuel electrode and the oxidant electrode to generate water H₂O so that the hot water is supplied to the hot water heater 34 by means of the pump 33b to heat water in the heat application unit such as the toilet seat.

According to the embodiment of the present invention, the water vapor, which is included in each of the exhaust gas generated from the fuel electrode of the cell body 32 and the exhaust gas generated from the oxidant electrode thereof, is recovered as a heat source for the first and second condensation heat exchange sections 40a, 40b, in this manner, thus making the water independent and providing an effective utilization of heat.

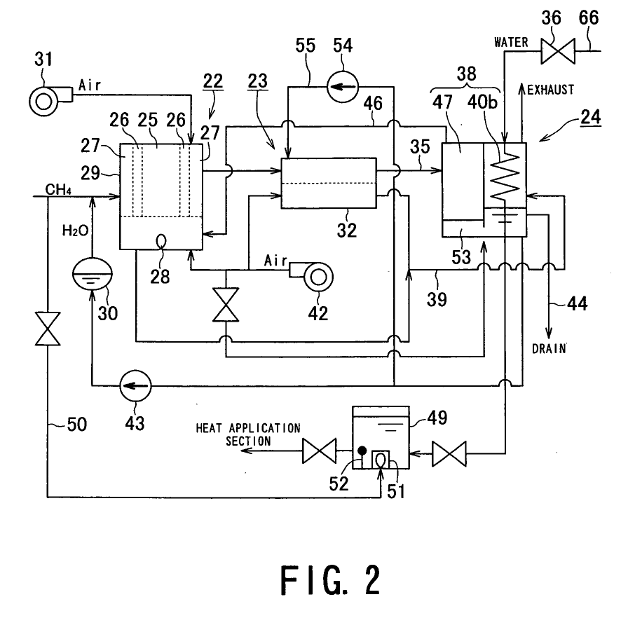

FIG. 2 is a schematic descriptive view illustrating the second embodiment of the solid polymer type fuel cell system according to the present invention. The same reference numerals are added to the same structural components as those of the first embodiment.

In the solid polymer type fuel cell system according to the second embodiment, the condensation heat exchange unit 38 of the heat recovery system 24 is divided into the gas-liquid separation section 47 and the second condensation heat exchange section 40b so that the gas-liquid separation section 47 is connected with the side of the fuel electrode of the cell body 32 through the fuel-exhaust gas pipe 35 and the second condensation heat exchange section 40b is connected with the side of the oxidant electrode of the cell body 32 through the oxidant-exhaust gas pipe 39.

In addition, in the solid polymer type fuel cell system according to the second embodiment, water, for example, service water from the valve 36 of the water supply unit 66 is subjected to the heat exchange in the second condensation heat exchange section 40b and a hot water storage bath 49, which temporarily stores the hot water obtained through the heat exchange so as to supply the hot water to the heat application unit, is provided with a sub-burning unit 51 for burning the fuel, for example, methane CH₄, which is supplied from the fuel supply system (not shown) through a fuel pipe 50. The sub-burning unit 51 is operative under instructions from a temperature sensor 52 provided in the hot water storage bath 49.

In the solid polymer type fuel cell system according to the second embodiment, the gas-liquid separation section 47 and the second condensation heat exchange section 40b are provided at the respective bottoms thereof with a common drain pool 53 so that drain from the drain pool 53 is supplied to the gas-liquid separation section 30 through a pump 43 and the remaining part of drain is supplied to the side of the fuel electrode of the cell body 32 through a drain supply pipe 55, and further, heat generated on the sides of the polymer membrane, the fuel electrode and the oxidant electrode along with generation of electricity in the cell body 32 is removed, thus causing a so-called latent heat cooling, when moving the drain from the side of the fuel electrode to the side of the oxidant electrode. The remaining structural components are the same as those of the first embodiment and redundant description is therefore omitted.

According to the embodiment of the present invention, the water vapor, which is included in each of the exhaust gas generated from the burning section 28 of the reforming unit, the exhaust gas generated from the fuel electrode of the cell body 32 and the exhaust gas generated from the oxidant electrode thereof, is recovered by means of each of the gas-liquid separation section 47 and the second condensation heat exchange section 40b so that the recovered drain is supplied to each of the hot water storage bath 49 and the fuel electrode of the cell body 32, thus making the water independent and providing an effective utilization of heat.

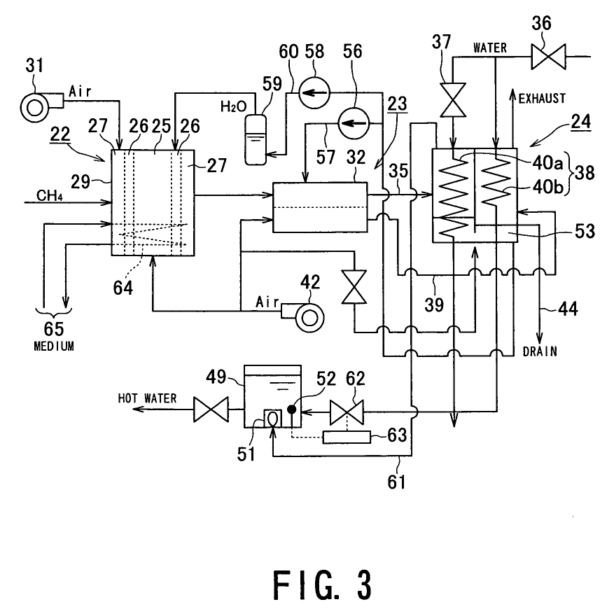

FIG. 3 is a schematic descriptive view illustrating the third embodiment of the solid polymer type fuel cell system according to the present invention. The same reference numerals are added to the same structural components as those of the first embodiment.

The solid polymer type fuel cell system according to the third embodiment is provided with the first drain supply pipe 57, which performs the so-called latent heat cooling system in which the drain generated in each of the first condensation heat exchange section 40a and the second condensation heat exchange section 40b of the condensation heat exchange unit 38 is supplied to the side of the fuel electrode of the cell body 32 by means of the pump 56 so as to cool the sides of the fuel electrode and the oxidant electrode with the use of the drain water, on the one hand, and the second drain supply pipe 60 for supplying the above-mentioned drain to the CO transformer 26 of the reforming unit 29 in the form of water vapor H₂O through the pump 58 and the gas-liquid separation unit 59.

In addition, in the solid polymer type fuel cell system according to the third embodiment, there is provided a gas supply pipe 61 for supplying the gas generated in the first condensation heat exchange section 40a to the sub-burning unit 51 of the hot water storage bath 49, a temperature sensor 52 detects the temperature of the hot water supplied from the second condensation heat exchange section 40b to the hot water storage bath 49 and there is provided a valve-opening computing unit 63 for controlling the valve opening of a temperature control valve 62, when the detected signals exceed the predetermined temperature.

In the solid polymer type fuel cell system according to the third embodiment, the reforming unit 29 is provided with a heat exchange section 64 to cool the reforming unit 29. There is provided a medium supply and discharge pipe 65 for supplying the medium as heated to the heat application unit (not shown). The remaining structural components are the same as those of the first embodiment and redundant description thereof is therefore omitted herein.

According to the third embodiment of the present invention, there is provided the first drain supply pipe 57 for causing the fuel electrode side of the cell body 32 to recover part of the drain, which is generated in the drain pool 53 of the first condensation heat exchange section 40a and the second condensation heat exchange section 40b, on the one hand, and the second drain supply pipe 60 for causing the CO transformer 26 of the reforming unit 29 to recover the remaining of the drain in the form of water vapor H2O, on the other hand, thus making the water independent.

In addition, in the third embodiment, there is provided the gas supply pipe 61 for supplying the gas generated from the first condensation heat exchange section 40a to the sub-burning unit 51 of the hot water storage bath 49, the reforming unit 29 is provided with the heat exchange section 64 and there is provided the medium supply and discharge pipe 65 for supplying the obtained medium as heated to the heat application unit, thus providing an effective utilization of heat.

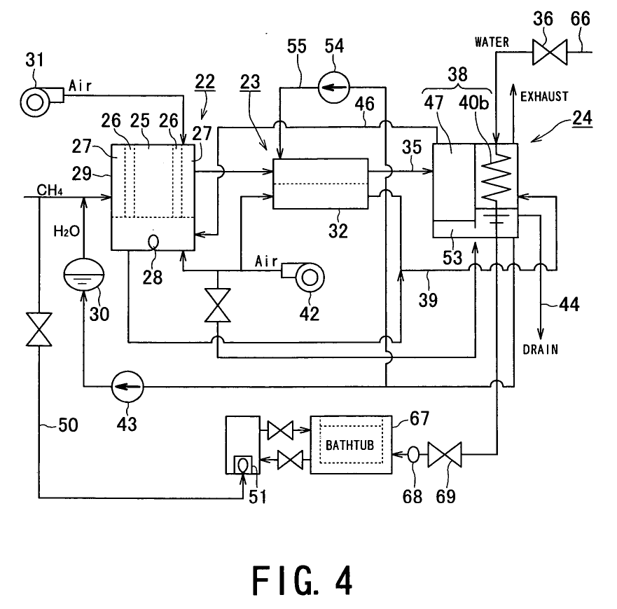

FIG. 4 is a schematic descriptive view illustrating the fourth embodiment of the solid polymer type fuel cell system according to the present invention. The same reference numerals are added to the same structural components as those of the first and second embodiments.

In the solid polymer type fuel cell system according to this fourth embodiment, the exhaust gas supplied from the side of the oxidant electrode of the cell body 32 through the oxidant-exhaust gas pipe 39 is utilized as the source of heat in the second condensation heat exchange section 40b of the condensation heat exchange unit 38 so as to heat water from the water supply unit 66 into hot water, and there are provided a bathtub 67 for storing the above-mentioned hot water to use same as bath, the sub-burning unit 51 for burning the fuel, for example, methane CH₄, which is supplied from the fuel supply system (not shown) through the fuel pipe 50 and the temperature control valve 69 disposed on the inlet side of the bathtub 67 for controlling the valve opening under instructions of the temperature sensor 68 for detecting the temperature of the bath in the bathtub 67. The remaining structural components are the same as those of the first and second embodiments and description thereof is therefore omitted herein.

According to the fourth embodiment, there are provided the bathtub 67 for utilizing, as the bath, the hot water generated in the second condensation heat exchange section 40b of the condensation heat exchange unit 38, the sub-burning unit 51 for burning the fuel supplied from the fuel pipe 50 of the fuel supply system to reheat the hot water, and the temperature control valve 69 for controlling the bath temperature, thus providing an effective utilization of heat under a proper temperature control.

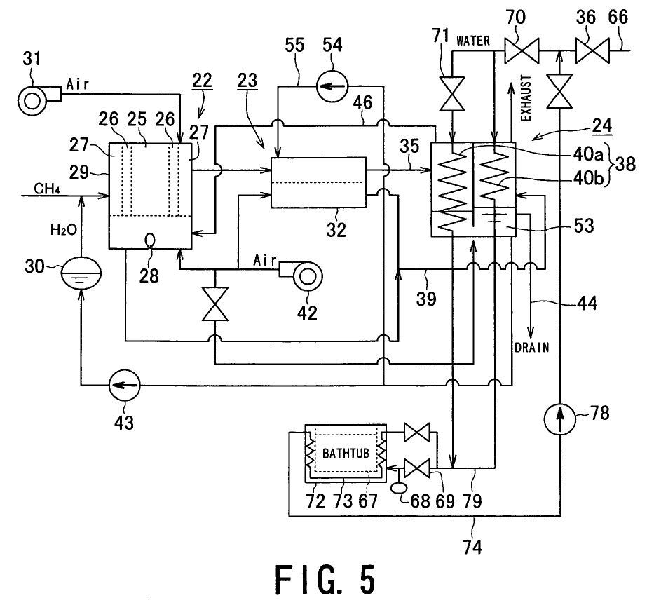

FIG. 5 is a schematic descriptive view illustrating the fifth embodiment of the solid polymer type fuel cell system according to the present invention. The same reference numerals are added to the same structural components as those of the first and second embodiments.

In the solid polymer type fuel cell system according to this fifth embodiment, water, for example, service water, which is supplied through a faucet 36, valves 70, 71 of the water supply unit 66 to each of the first condensation heat exchange section 40a that is connected from the side of the fuel electrode of the cell body 32 through the fuel-exhaust pipe 35 and the second condensation heat exchange section 40b that is connected from the side of the oxidant electrode of the cell body 32 through the oxidant-exhaust gas pipe 39, is heated to be hot water, and there are provided a bathtub 67 for storing part of the above-mentioned hot water to use same as bath, a heat exchange section 73 embedded in a wall portion 72 of the bathtub 67 for utilizing the remaining hot water as the heating source for the bath, and a hot water returning pipe 74 for returning the hot water discharged from the heat exchange section 73 to the outlet side of the faucet 36 of the water supply unit 66 by means of a pump 78.

In addition, the solid polymer type fuel cell system according to the fifth embodiment is provided with a bath pipe 79 for supplying the hot water, which is generated in the first condensation heat exchange section 38 and the second condensation heat exchange section 40 of the condensation heat exchange unit 38, to the bathtub 67 in the form of bath, and with a temperature control valve 69 for controlling the valve opening under instructions of the temperature sensor 68, which is provided in the bath pipe 79. The remaining structural components are the same as those of the first and second embodiments and description thereof is therefore omitted herein.

According to the fifth embodiment, the water from the water supply unit 66 is heated to be the hot water by means of the first condensation heat exchange section 40a and the second condensation heat exchange section 40b, part of the hot water is subjected to control with the use of the temperature control valve 69 and the remaining hot water is supplied to the heat exchange section 73 provided in the wall portion 72 for the purpose of heating the bath, when supplying the hot water to the bathtub 67 in the form of bath, and there is provided a hot water returning pipe 74 for returning the hot water as reheated to the water supply unit 66, thus providing an effective utilization of heat under a proper temperature control.

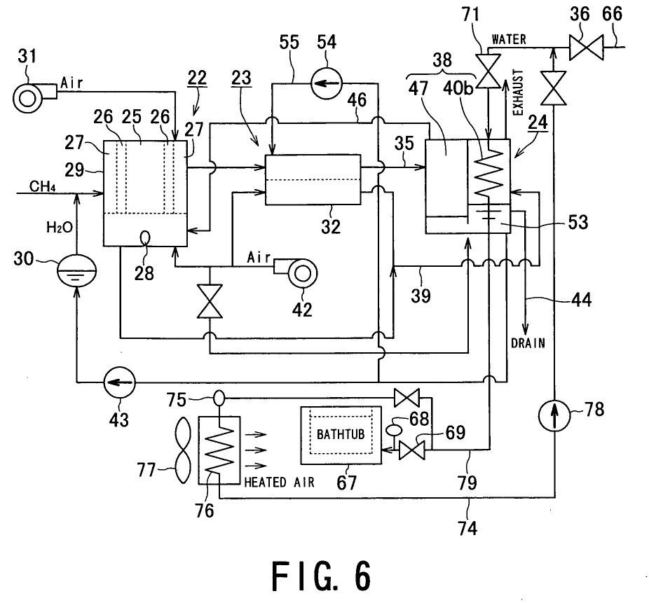

In the fifth embodiment, the water from the water supply unit 66 is heated to be the hot water by means of the first condensation heat exchange section 40a and the second condensation heat exchange section 40b and the above-mentioned hot water is supplied to the bathtub 67 in the form of bath so as to utilize part of the hot water as the reheating source. However, the present invention is not limited only to such an embodiment, and there may be adopted, for example, measures as shown in FIG. 6 of supplying the hot water from the second condensation heat exchange section 40b of the condensation heat exchange unit 38 to the bathtub 67, while supplying part of the hot water to a heat exchange section 76 provided in the outside of the bathtub, under the control of the temperature sensor 75, raising the temperature of air sucked by means of the fan 77 and supplying hot air having the raised temperature to the heat application unit such as a drying room or a bath room. The hot water, which has been subjected to the temperature-raising process of the air supplied from the fan 77, is returned to the water supply unit 66 through the hot water returning pipe 74.

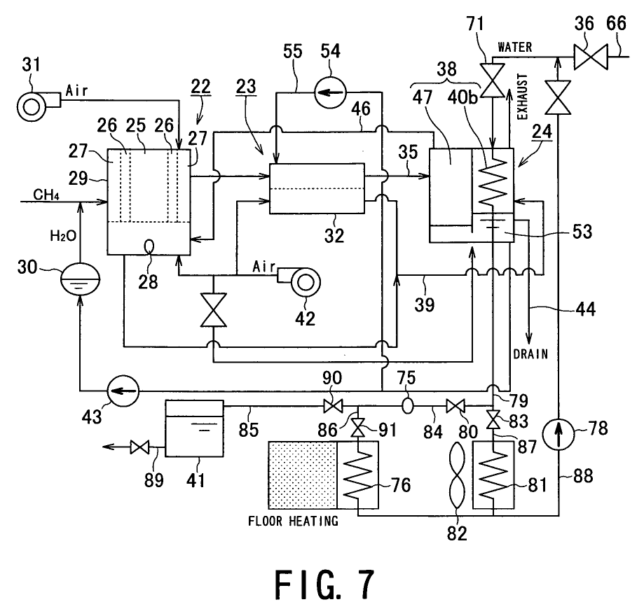

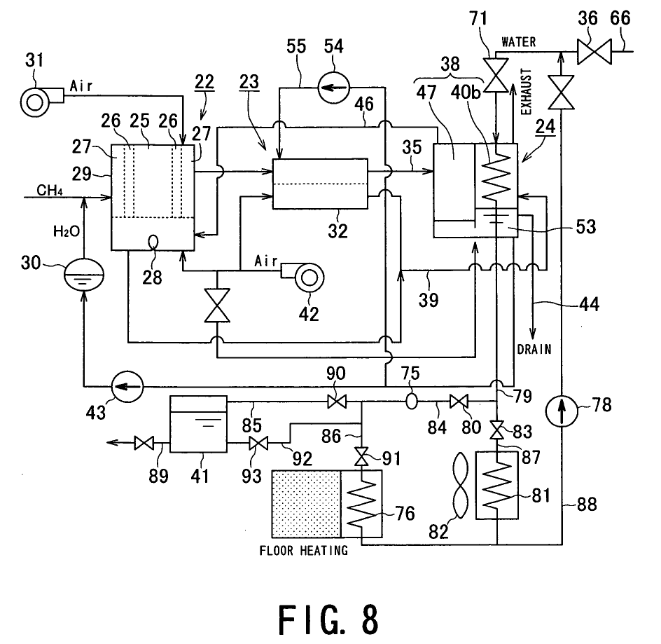

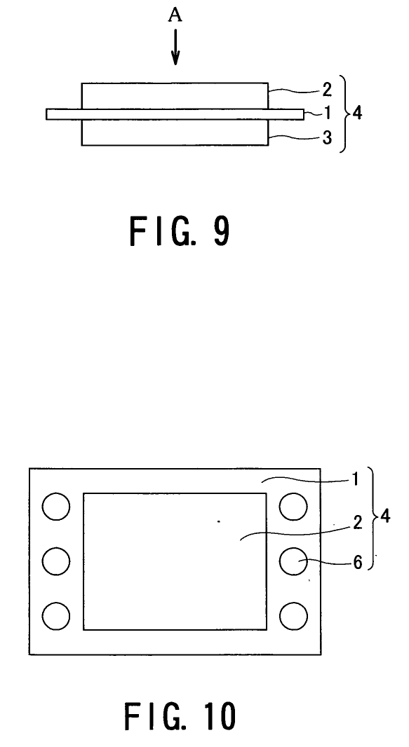

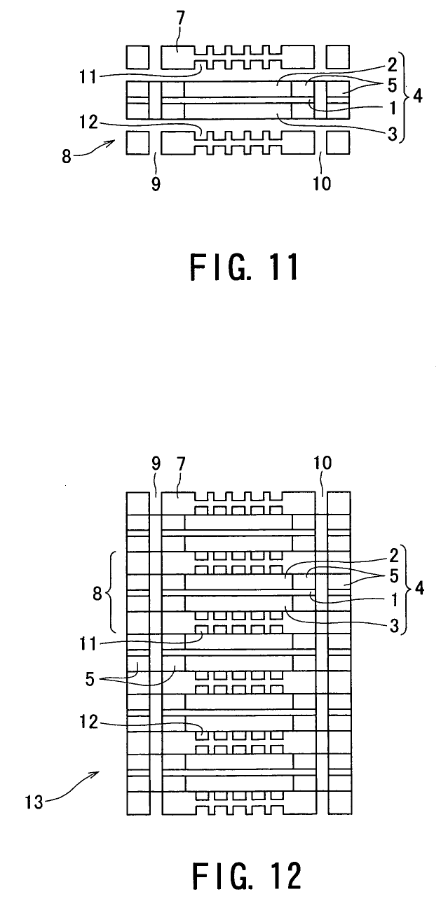

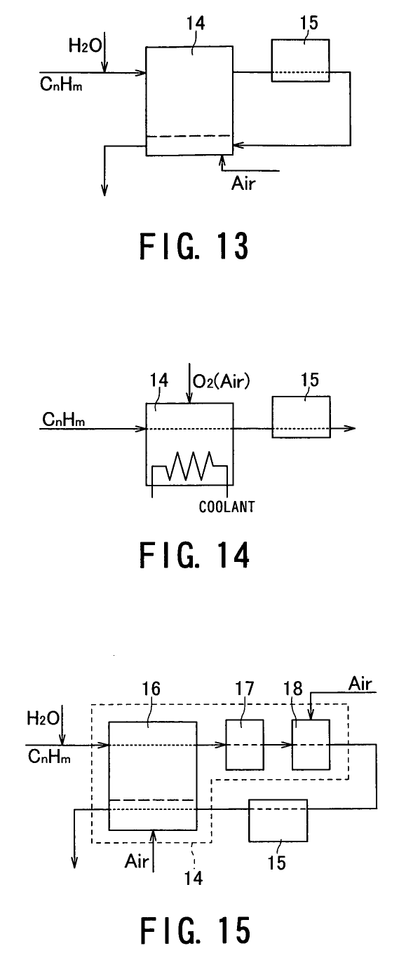

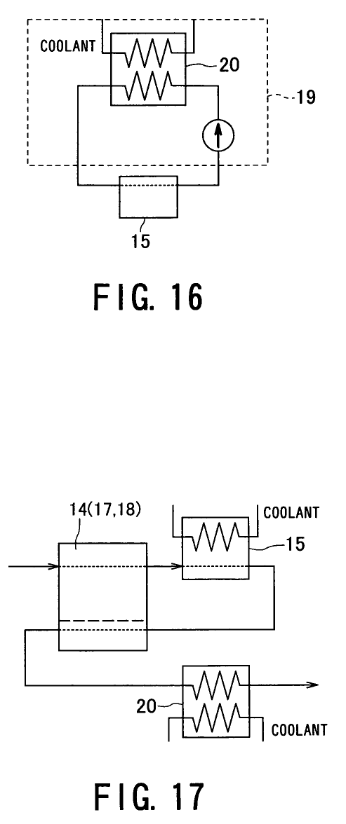

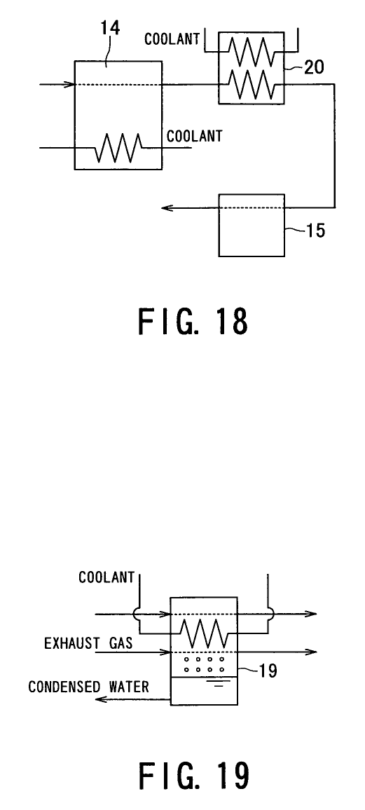

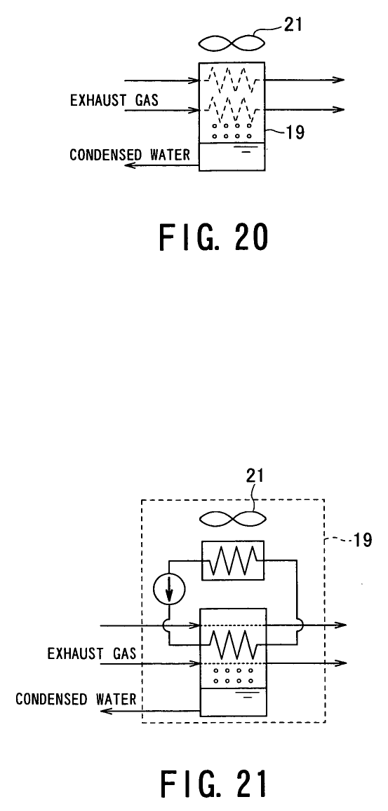

FIG. 7 is a schematic descriptive view illustrating the seventh embodiment of the solid polymer type fuel cell system according to the present invention. The same reference numerals are added to the same structural components as those of the first and sixth embodiments.

In the solid polymer type fuel cell system according to this seventh embodiment, water from the water supply unit 66 is heated to be hot water in the second condensation heat exchange section 40b of the condensation heat exchange unit 38, utilizing, as the heating source, the exhaust gas supplied from the side of the oxidant electrode of the cell body 32 through the oxidant-exhaust gas pipe 39, the hot water is supplied to the hot water storage unit 41 through pipes 79, 84, 85 and then supplied to the first heat application unit for the purpose of hot water supply or taking a shower, as an occasion demands.

In addition, there is adopted a structure in which a heat exchange section 76 serving as the second heat application unit for the purpose of floor heating is provided in parallel with the hot water storage unit 41 so that the heat is retuned to the water supply side of the condensation heat exchange unit 38 by means of a pipe 88 and a pump 78, after supplying the heat to the floor. Application of the heat exchange section 76 is not limited only to the floor heating, but it may be applied to a heating device or a hot air supplying device which is built in a wall.

In addition, an air-cooled heat exchange section 81 is provided, through a valve 83, a pump 78, and a pipe 87, as a temperature (thermal energy) control device for the hot water, which has passed through the condensation heat exchange unit 38, so that the above-mentioned hot water is introduced into the air-cooled heat exchange section 81 by the operation of the pump 78 and cooled with air supplied by the fan 82 and then retuned to the water supply side of the condensation heat exchange unit 38.

The heat exchange section 81 and the fan 82 are used in case where the heat utilization is not conducted in the first and second heat application units or the thermal energy as utilized is to be decreased. With respect to the control device thereof, the temperature sensor 75 detects the temperature of the hot water, which is to be supplied to the hot water storage unit 41 and the heat exchange section 76 for the floor heating, and the detected signals are fed back relative to the opening of the valves 80 and 83, and the number of rotations of the pump 78, thus making a control. The opening control of the valve 36 for the water supply unit may also be made.

According to the seventh embodiment, the water from the water supply unit 66 is heated to be the hot water in the second condensation heat exchange section 40b, and there is provided the temperature control unit such as the air-cooled heat exchange section 81 and the temperature sensor 75 for controlling the temperature or flow rate of the hot water, when supplying the hot water to the first heat application unit through the hot water storage unit 41 or to the second heat application unit provided in parallel with it, thus providing an effective utilization of heat under a proper temperature control.

Providing the pipe 92 and the valve 93 as the device for connecting the hot water storage unit 41 to the pipe 86, which is disposed on the upstream side of the heat exchange section 76 for the floor heating, makes it possible to supply the hot water as stored in the hot water storage unit 41 by the operation of the pump 78 in case where the solid polymer type fuel cell system has not as yet been initiated or during a period of time from the initiating of the system to the generation of electricity. In addition, circulation of the water in the hot water storage unit 41 leads to prevention of occurrence of corrosion. In this case, the pipe 92 may not be directly connected to the hot water storage unit 41, but be connected to the pipe 89.

Industrial Applicability

As described above in detail, the solid polymer type fuel cell system according to the present invention comprises the fuel reforming system, the electricity-generating system and the heat recovery system so that electricity is generated in accordance with the chemical reaction, which is caused in the electricity-generating system, of reformed fuel generated in the fuel reforming system with air, and the thus generated exhaust gas is supplied to the heat recovery unit and the water from the water supply unit is heated to be hot water, utilizing the exhaust gas as the heating source so that the hot water is supplied to the heat application unit, while utilizing the drain as isolated from the exhaust gas in at least one of generation of the reformed fuel in the fuel reforming system and hot-water supply, on the other hand, thus making the water independent and providing effective utilization of heat.

1. A solid polymer type fuel cell system, in which a fuel reforming system and a heat recovery system are combined with an electricity-generating system for chemically generating electricity, wherein said heat recovery system comprises a water supply unit, a condensation heat exchange unit for converting water supplied from said water supply unit into hot water, and a hot water storage unit for temporarily storing the hot water from said condensation heat exchange unit and supplying same to a heat application unit.

2. A solid polymer type fuel cell system as claimed in claim 1, wherein said condensation heat exchange unit is divided into a first condensation heat exchange section and a second condensation heat exchange section, said first condensation heat exchange section being connected with a side of a fuel electrode of a cell body and said second condensation heat exchange section being connected with a side of at least an oxidant electrode of said cell body.

3. A solid polymer type fuel cell system as claimed in claim 1, wherein said condensation heat exchange unit is divided into a gas-liquid separation section and a second condensation heat exchange section, said gas-liquid separation section being connected with a side of a fuel electrode of a cell body and said second condensation heat exchange section being connected with a side of at least an oxidant electrode of said cell body.

4. A solid polymer type fuel cell system as claimed in claim 2, wherein said first condensation heat exchange section and said second condensation heat exchange section are provided at respective bottoms thereof with a common drain pool.

5. A solid polymer type fuel cell system as claimed in claim 3, wherein said gas-liquid separation section and said second condensation heat exchange section are provided, at respective bottoms thereof, with a common drain pool.

6. A solid polymer type fuel cell system as claimed in claim 4, wherein said drain pool is provided with an air supply unit.

7. A solid polymer type fuel cell system as claimed in claim 5, wherein said drain pool is provided with an air supply unit.

8. A solid polymer type fuel cell system as claimed in claim 1, wherein said hot water storage unit is a hot water tank.

9. A solid polymer type fuel cell system as claimed in claim 1, wherein said hot water storage unit is provided with a sub-burning unit for heating the hot water, which is supplied from said condensation heat exchange unit, utilizing at least one of a part of fuel supplied to the fuel reforming system and unreacted fuel discharged from the electricity-generating system.

10. A solid polymer type fuel cell system as claimed in claim 1, wherein said hot water storage unit is provided with a control valve for controlling a flow rate of the hot water supplied from the condensation heat exchange unit and with a valve-opening computing unit for processing a valve opening signal based on a temperature signal for the hot water and supplying same to the control valve.

11. A solid polymer type fuel cell system as claimed in claim 1, wherein said hot water storage unit is a bathtub.

12. A solid polymer type fuel cell system as claimed in claim 11, wherein said bathtub is provided with a heat exchange section received in a wall portion thereof, said heat exchange section being provided with a device for supplying the hot water from said condensation heat exchange unit and with a device for returning the hot water from said heat exchange section to an inlet of said condensation heat exchange unit.

13. A solid polymer type fuel cell system, in which a fuel reforming system and a heat recovery system are combined with an electricity-generating system for chemically generating electricity, wherein said heat recovery system comprises a water supply unit; a condensation heat exchange unit for converting water supplied from said water supply unit into hot water; a bathtub for utilizing the hot water from said condensation heat exchange unit as a hot bath; a heat exchange section for converting air into a hot-air with a use of the hot water from said condensation heat exchange unit as a heating source and supplying the hot-air to a heat application unit; and a device for returning the hot-water discharged from said heat exchange section to a water supply side of said condensation heat exchange unit.

14. A solid polymer type fuel cell system, in which a fuel reforming system and a heat recovery system are combined with an electricity-generating system for chemically generating electricity, wherein said heat recovery system comprises a water supply unit; a condensation heat exchange unit for converting water supplied from said water supply unit into hot water; and a hot water storage unit for temporarily storing the hot water from said condensation heat exchange unit and supplying same to a heat application unit, and said electricity-generating system is provided with a line for supplying part of condensed water, which is generated in said condensation heat exchange unit, to at least one of sides of a fuel electrode of a cell body and an oxidant electrode.

15. A solid polymer type fuel cell system, in which a fuel reforming system and a heat recovery system are combined with an electricity-generating system for chemically generating electricity, wherein said heat recovery system comprises a water supply unit; a condensation heat exchange unit for converting water supplied from said water supply unit into hot water, a device for supplying the hot water from said condensation heat exchange unit to a first heat application unit, a device for supplying said hot water to a second heat application unit, which is provided in parallel with said first heat application unit, a device for returning water, which has passed through said second heat application unit, to a water supply side of said condensation heat exchange unit, and an adjusting device for controlling an amount of heat supplied to said first or second heat application unit.

16. A solid polymer type fuel cell system as claimed in claim 15, further comprising a hot water storage unit provided on an upstream hot-water side of said first heat application unit, and a device for connecting a hot-water discharging side of said hot water storage unit with a hot-water supply side of said second heat application unit.
